(19) United States
(12) Patent Application Publication
(10) Pub. No.: US 2006/0012685 A1
(43) Pub. Date: Jan. 19, 2006

(54) Wireless surveillance and communications system

(75) Inventor: Daniel J. Gannon, Tustin, CA (US)

Correspondence Address: THE LAW OFFICES OF ROBERT T. BRAUN, 10810 TURNLEAF LANE, TUSTIN RANCH, CA, 92782, US

(73) Assignee: HOP-ON WIRELESS, INC.

(21) Appl. No.: 10/893,200

(22) Filed: Jul. 17, 2004

(51) Int. Cl. H04N 5/232

(52) U.S. Cl. 348/211.2

(57) ABSTRACT

A camera system is provided with a camera body, a supporting arm, and a supporting base. The camera captures images on a CCD optical image sensor, transmits the images by wire through the supporting arm into the supporting base, and transmits them wirelessly from the supporting base to a monitor system on frequencies of at least 2.4 GigaHertz. The monitor system displays images from one or more sources on an LCD color visual display, and projects corresponding audio from a speaker. Additionally, the monitor system may have a microphone and wireless transmission system which transmits signals to a wireless reception system in the camera system. The camera system can then project audio signals over a speaker, allowing two-way audio communication from the camera system to the monitor system.

### BACKGROUND OF THE INVENTION

Field of the Invention

The present invention relates to audio and video surveillance systems. More particularly, one or more camera systems capture video and audio information, and transmit the information wirelessly to a monitor system. The system also allows transmission of audio information from the monitor system to the one or more camera systems, allowing two-way audio communication between users at both locations.

Prior surveillance systems initially transmitted across wires. Early wireless systems transmitted audio only, then video only, and finally audio and video. Some systems were black and white, or used less than 24 frames per second, resulting in less than full motion.

Recent systems have transmitted in color at full motion frame rates, but suffer from several other issues. Many systems are designed to be viewed on a standard television or monitor. Therefore, they transmit at VHF frequencies, somewhere less than 300 MHz. These systems suffer from two main drawbacks. First, the range of transmission is very low, particularly with low power transmitters and through objects, such as walls and ceilings. Second, the television or monitor generally has not been portable.

Other systems have transmitted at higher frequencies, allowing them to be designed to be viewed on a portable monitor. However, the designers have had to make a significant tradeoff with these systems.

Cameras using a charge coupled device (CCD) provide increased sharpness over cameras using a complementary metal oxide semiconductor (CMOS). Where a CMOS camera may sharply define a subject at 12 feet, a CCD camera can equally define a subject at 40 feet. Therefore, designers would prefer to use CCD cameras over the inferior CMOS cameras.

CCD cameras require more advanced circuitry than CMOS cameras. This circuitry tends to heat up more than the CMOS counterparts. At transmission frequencies of up to 1.2 GHz, this heat does not pose a significant problem. Therefore, transmission systems using CCD cameras were available at up to 1.2 GHz frequencies. While this transmission frequency provides increased range and picture quality over VHF frequencies, it is still very susceptible to walls and other objects in the line of transmission.

It would have been preferable to transmit at 2.4 GHz. However, because the cameras and transmission circuitry needed to be in a relatively compact space, the additional heat from the CCD camera circuitry posed a significant problem. The signal would degrade, and eventually the transmission would fail completely. Therefore, prior 2.4 GHz systems would be limited to CMOS cameras, which ran at lower heat. The tradeoff, as stated above, is much lower camera capture quality.

### SUMMARY OF THE INVENTION

According to one aspect of the present invention, a camera system is provided for use in a wireless transmission system. The camera system includes a camera body mounted on a supporting base. A lens is mounted to and a CCD image sensor is mounted within the camera body. A microphone is mounted on the supporting base. Wireless transmission system circuitry is located within the supporting base, to transmit light received by the CCD image sensor and sounds received by the microphone. The circuitry transmits on a frequency of at least 2.4 GigaHertz.

The camera body may be mounted on the supporting base to allow rotation up, down, left, and right. To facilitate this, the camera body may be mounted on a supporting arm, which is in turn mounted to the supporting base. The supporting arm can rotate relative to the supporting base in a first plane, and the camera body can rotate relative to the supporting arm in a second plane substantially orthogonal to the first plane.

The supporting arm may be substantially hollow, and the CCD image sensor may be connected to the wireless transmission system circuitry by a wire which runs substantially through the hollow supporting arm, from the camera body to the supporting base.

The camera system may include a light source mounted near the lens, to illuminate the area generally in front of the lens, and to thereby increase the light received through the lens. The light source may provide visible or infrared light, and may be a plurality of light emitting diodes. The light emitting diodes may be arranged in a plurality of concentric circles around the lens.

The camera system may include a wireless reception system in the supporting base for receiving signals from a remote transmitter. The signals may be audio signals which can then be projected by a speaker.

According to another aspect of the present invention, a monitor system is provided to receive wirelessly transmitted signals, and to display images and project audio from those received signals. The monitor system may be portable, and may be powered by batteries or alternating current power. The batteries may be rechargeable, and the alternating current power may also recharge the batteries while simultaneously powering the system. Again, the transmission frequency is at least 2.4 GigaHertz.

The monitor system may receive signals from more than one remote source. The monitor system may display images and project sounds corresponding to one remote source for a predetermined period of time, then switch to another source. Preferably, the monitor system includes controls to allow a user to select one of the sources for display and projection.

Additionally, the monitor system may include a microphone to receive audible sounds, and a wireless transmission system to transmit that audio information to a remote receiver. The microphone may have an activation control, or may automatically activate when audio sounds are detected. In the case where the monitor system can receive signals from more than one remote source, one aspect of the system transmits signals only to the remote receiver corresponding to the remote source whose signals are being displayed and projected. Another aspect of the system transmits signals to all receivers corresponding to all remote sources operably connected to the monitor system.

In combination, the monitor system and one or more camera systems make a complete wireless surveillance and communications system.

According to yet another aspect of the present invention, a wireless reception system is provided. The wireless reception system includes a receiver adapted to wirelessly receive video and audio signals from a plurality of remote sources at a frequency of at least 2.4 GigaHertz. It also includes a plurality of source selector controls and source indicators, one for each remote source. The controls allow a user to selectr a particular source, and the indicator indicates which source is selected. There is also a scan selector control, directing the system to alternately select each remote source for a predetermined period of time. Finally, there is an output jack, to output signals from the currently selected source to a display and speaker. The output jack may be a coaxial cable jack.

The predetermined period of time can be selected or modified by a user, and can be different for each remote source. There can also be an additional audio/video output. The system may include a remote control, allowing a user to select any of the controls or to modify the predetermine period of time remotely.

### BRIEF DESCRIPTION OF THE DRAWINGS

The foregoing and other objects, features and advantages of the invention will be apparent from the following more particular description of a preferred embodiment of the invention as illustrated in the accompanying drawings wherein:

FIG. 1 shows a camera system, according to the prior art.

FIG. 2 shows a monitor system, according to the prior art.

FIG. 3 shows a block diagram of a surveillance system, according to the prior art.

FIG. 4 shows an embodiment of a camera system, according to the present invention.

FIG. 5 shows an embodiment of a monitor system, according to the present invention.

FIG. 6 shows an alternate embodiment of a wireless reception system, according to the present invention.

### DETAILED DESCRIPTION OF THE PREFERRED EMBODIMENT

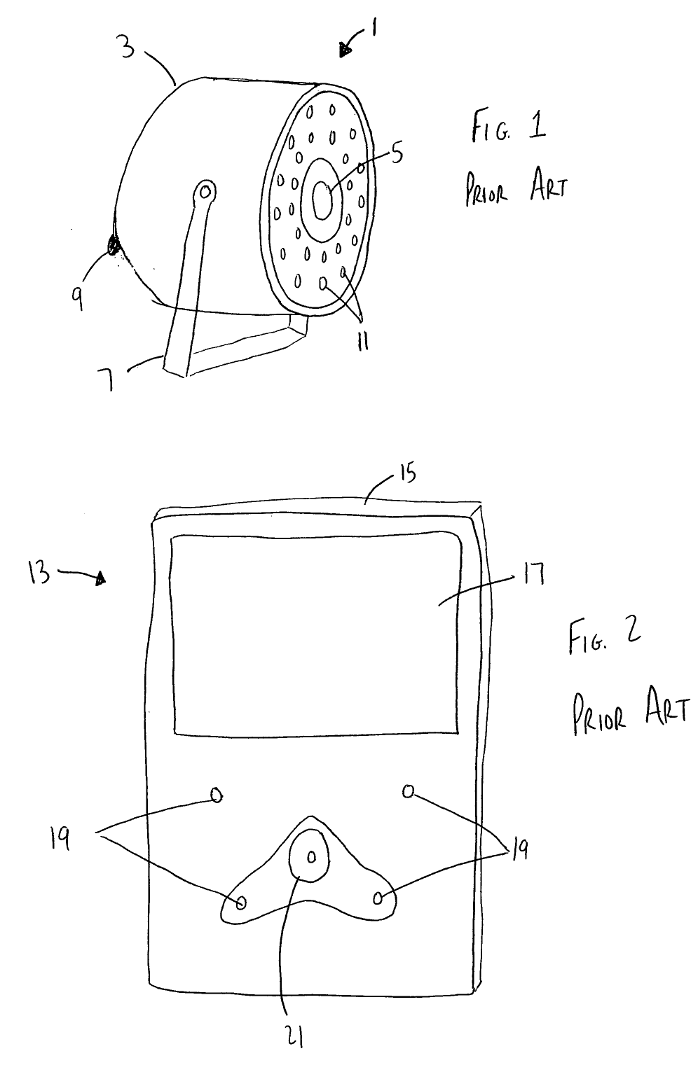

Referring to FIG. 1, there is shown a camera system 1 according to the prior art. A camera body 3 includes a lens 5. The lens 5 focuses light onto a one-quarter inch CCD or a CMOS sensor (not shown), positioned within the camera body 3. The camera body 3 may be mounted on a stand 7. There is also a microphone 9 attached to the rear of the camera body 3, for receiving sound.

Surrounding the lens 5 are light emitting diodes 11. These light emitting diodes 11 may emit visible light or infrared light. The light emitting diodes 11 increase the illumination of the subject being viewed by the lens 5, thereby increasing the light on the CCD or CMOS sensor.

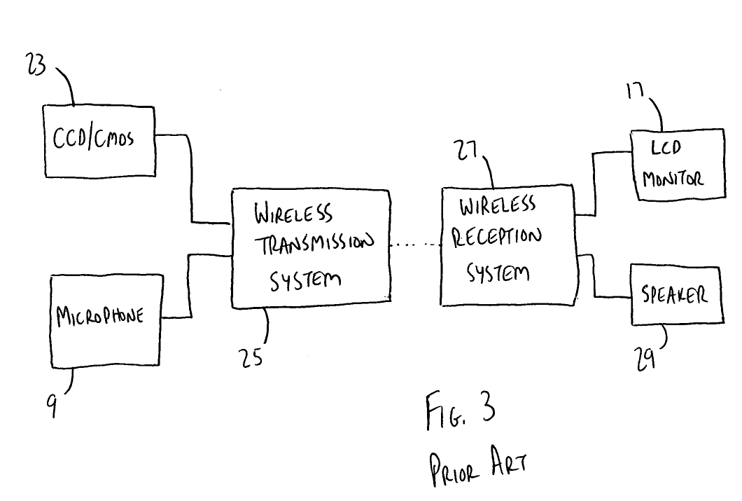

Referring to FIG. 2, there is shown a monitor system 13, according to the prior art. A housing 15 contains an LCD monitor 17, for displaying images. The housing 15 also contains a speaker (not shown) for projecting audible sound. Located on the housing 15 are a plurality of input selector buttons 19, for selecting image and audio signals from a plurality of sources.

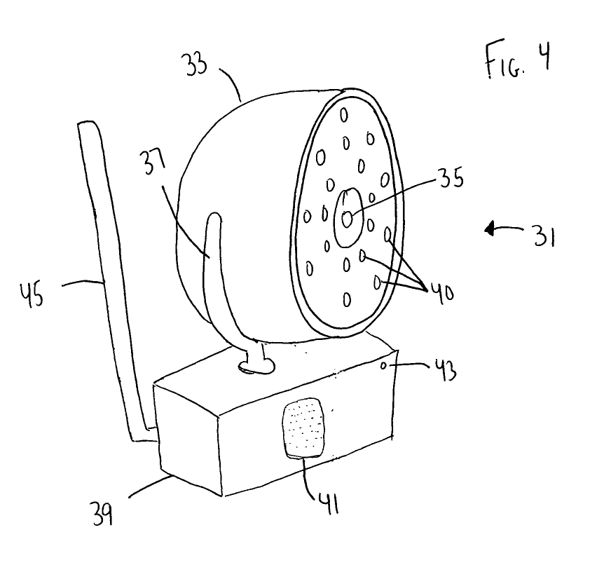

Referring to FIG. 3, the operation of a prior art wireless surveillance system including a camera system 1 and a monitor system 13 is shown. A CCD or CMOS sensor 23 and microphone 9 within or on the camera body 3 each send signals to a wireless transmission system 25. The wireless transmission system 25 is also located within the camera body 3. The wireless transmission system 25 transmits the audio and image information to a wireless reception system 27, located in the housing 15. As stated earlier, if the sensor 23 is a CCD, then the transmission occurs at no greater than 1.2 GHz. If the sensor 23 is a CMOS, then the transmission can occur at up to 2.4 GHz. The wireless reception system 27 separates the received signals into image signals, which are then passed to the LCD monitor 17 for display, and audio signals, which are then passed to a speaker 29 for projection.

For CCD camera systems, the wireless transmission system 25 and wireless reception system 27 are designed to transmit NTSC signals on a frequency of 1.2 GHz. This frequency presents several problems. First, picture quality is not optimal, compared with 2.4 GHz. Second, interference often occurs, further degrading picture quality. Third, because the system is designed to transmit signals to a remote location often through walls or other obstructions, transmission range is severely limited.

For CMOS camera systems, the wireless transmission system 25 and wireless reception system 27 can transmit at frequencies up to 2.4 GHz. However, CMOS camera systems are inferior to CCD camera systems. Therefore, the initially captured picture is of a much lower quality than with CCD camera systems.

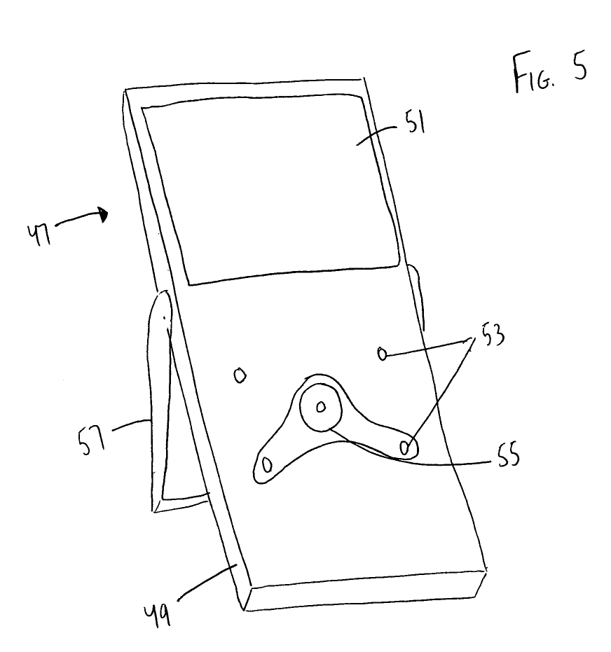

Referring to FIG. 4, there is shown a camera system 31 according to the present invention. A camera body 33 includes a lens 35. Located within the camera body 33 is a CCD optical image sensor (not shown). The CCD optical image sensor receives the light through the lens 35, and converts the image to a digital signal suitable for transmission. The camera body 33 is mounted to a supporting arm 37, which is in turn mounted on a supporting base 39. The camera body 33 may be rotated up or down relative to the supporting arm 37, and the supporting arm may be rotated left or right relative to the supporting base 39. These two ranges of motion allow the camera body 33 to pan up, down, left, or right.

The supporting arm 37 is hollow. Wires (not shown) extend from the CCD optical image sensor in the camera body 33, out through the supporting arm 37, and down into the supporting base 39. Once inside the supporting base 39, the wires connect to the transmission circuitry (not shown). By removing the transmission circuitry from the camera body 33 into the supporting base 39, the problems associated with transmitting CCD camera images at 2.4 GHz are removed, and transmission can occur at 2.4 GHz or higher frequencies. The supporting base 39 can provide adequate ventilation to cool the transmission circuitry, and the distance between the transmission circuitry and the CCD optical image sensor is increased. Despite this, the camera system 31 remains both compact and portable.

Surrounding the lens 35 are several light emitting diodes 40 for illuminating the area in front of the lens 35. Preferably, the light emitting diodes 40 are arranged in substantially concentric circles, and most preferably there are two substantially concentric circles. The light emitting diodes 40 may be visible light, infrared light, or any other suitable illumination. The light emitting diodes 40 increase the illumination of the subject being focused on by the lens 35, thereby increasing the amount of light passed to the CCD optical image sensor. Light sources other than light emitting diodes 40 may be used.

Located on the front face of the supporting base 39 is a microphone 43. The microphone 43 receives audio signals, and is connected to the transmission circuitry, to allow the circuitry to transmit audio signals along with the corresponding images.

Locating the microphone 43 on the front face of the supporting base 39 provides several advantages. First, unlike prior art surveillance systems where the microphone 9 was mounted on the camera body 3, the microphone 43 is facing the subject. This increases the range of the microphone 43. Additionally, space is not at such a premium on the supporting base 39 as it is on the camera body 3, so the microphone 43 can be larger. This also increases range and sensitivity.

The camera system 31 also uses rechargeable batteries (not shown). Preferably, these batteries are lithium-ion batteries, and are located in the supporting base 39.

An antenna 45 is attached to the supporting base 39. The antenna 45 facilitates transmission of image and audio signals, and reception of audio signals from a remote location.

A speaker (not shown) may be located on the supporting base 39. In a two-way communication system, the antenna 45 may receive signals from a remote location, which are translated into audio signals by reception circuitry (not shown), also located in the supporting base 39. The speaker would then project these audio signals, allowing full two-way communication between the camera system 31 and a remote location.

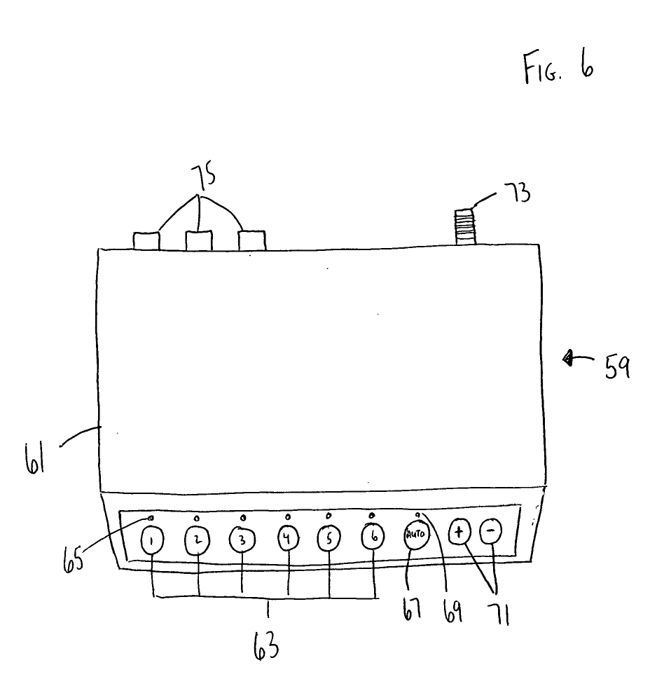

Referring to FIG. 5, there is shown a monitor system 47, according to the present invention. A housing 49 contains a wireless reception system (not shown) for receiving image and audio signals from a remote source. The remote source may be a camera system 31 according to the present invention, a camera system 1 according to the prior art, or any other suitable transmitter. The wireless reception system converts the received signals into images for display on a LCD color visual display 51, and into audio signals to be projected by a speaker (not shown). For a silent mode, the speaker can be disabled or muted.

Located on the housing 49 are a plurality of input selector buttons 53, for selecting image and audio signals from a plurality of remote sources. Preferably, the housing 49 is connected to a stand 57, which can be extended to allow the housing 49 to rest at a comfortable viewing angle. The stand 57 can also be retracted flat against the housing 49, to facilitate portability.

The housing 49 preferably includes a condenser microphone (not shown), to convert sound in to signals suitable for transmission. The signals can then be transmitted by a wireless transmission system (not shown) located within the housing 49, to a remote receiver, such as the camera system 31. The housing 49 may also include a microphone jack (not shown), to allow connection of an external microphone.

Either the condenser microphone or the external microphone may be controlled in a variety of ways. Either one could automatically activate upon receiving audio sounds of a predetermined level. This predetermined level could be adjusted by a user. With this “auto-on” activation, the wireless transmission system would also automatically transmit signals corresponding to the audio signals.

More preferably, the housing 49 could include a microphone control (not shown), which is selectively activated by a user and activates one of the microphones. The microphone control could also activate the wireless transmission system. The microphone control could be a sensitivity control, such as a dial, a button, or any other suitable control.

The input selectors 53 control which received images are displayed on the LCD color visual display 51, and which received audio signals are projected by the speaker. Additionally, the input selectors 53 could control to which remote receiver the wireless transmission system transmits the audio signals from the condenser microphone or external microphone.

The monitor system 47 contains a power source (not shown). The preferred power source is direct current batteries. The batteries are preferably rechargeable, and most preferably are four AA batteries. The housing 49 also may contain an input (not shown) for an alternating current power supply as a second power source. Preferably, the alternating current power supply would provide sufficient power to operate the monitor system 47, and simultaneously recharge the batteries.

Referring to FIG. 6, there is shown an alternate embodiment of a wireless reception system 59. This wireless reception system 59 is suitable for use with any of the same transmitters that can be used with the monitor system 47, but allows additional display options. The wireless reception system 59 contains a wireless receiver (not shown), capable of receiving signals from a plurality of sources. The wireless reception system 59 has a housing 61 containing an input selector button 63 for each of the possible sources. There is also a light emitting diode 65 for each of the input selector buttons 63. When the user depresses one of the input selector buttons 63, the corresponding light emitting diode 65 illuminates, indicating that the particular input source is selected. The light emitting diode 65 will also illuminate when the particular input source is selected by methods other than depressing the input selector button 63, as discussed more thoroughly below.

There is also a control button 67 and light emitting diode 69 for an auto-scan feature. When the user depresses the control button 67, the light emitting diode 69 illuminates, indicating that the wireless reception system 59 is in auto-scan mode. In this mode, the wireless reception system 59 will scan through the input sources in order, for a predetermined period of time. As each input source is selected, the corresponding light emitting diode 65 illuminates, along with the light emitting diode 69 for the auto-scan feature.

The housing 61 also has up and down buttons 71. These up and down buttons 71 allow the user to specify the length of time that a particular input source will be selected during the auto-scan feature. For example, the default selection time may be one second. The user will depress one of the input selector buttons 63. To display the corresponding input source for longer, the up button 71 will be pressed one or more times. To display the corresponding input source for a shorter time, the down button 71 will be pressed one or more times. The user will then press a different input selector button 63, and repeat the process with the up and down buttons 71. When the user selects the auto-scan feature by pressing the control button 67, the wireless reception system 59 will scan through the input sources in order, each for the preset time.

Regardless of the mode of operation, when a particular input source is selected, the wireless reception system 59 outputs the signal from that source onto a variety of outputs. The first alternative is a coaxial cable output 73, which can connect to a standard coaxial cable. Of course, the wireless reception system 59 has internal circuitry to convert the received signal to the appropriate output signal. The second alternative is audio/video outputs 75. Other suitable outputs are possible. This variety of outputs allows the wireless reception system 59 to display or project onto a television, monitor, personal computer, VCR, or any other suitable display. The monitor system 47 may also include audio/video inputs (not shown) to display signals received by the wireless reception system 59.

The wireless reception system 59 is also adapted to operate by remote control. Each of the controls on the housing 61 can have a counterpart control on a remote control (not shown). The remote control may operate by infrared, through an infrared sensor (not shown) on the housing 61, or by any other suitable remote transmission means.

While this invention has been described in detail with reference to certain preferred embodiments, it should be appreciated that the present invention is not limited to those precise embodiments. Rather, in view of the present disclosure, which describes the current best mode for practicing the invention, many modifications and variations would present themselves to those of skill in the art without departing from the scope and spirit of this invention. The scope of the invention is, therefore, indicated by the following claims rather than the foregoing description. All changes, modifications, and variations coming within the meaning and range of equivalency of the claims are to be considered within their scope.

What is claimed is:

1. A camera system for use in a wireless video transmission system, comprising:
a supporting base;
a camera body mounted on said supporting base;
a lens mounted to said camera body;
a CCD image sensor mounted within said camera body, positioned to receive light through said lens;
a microphone, mounted on said supporting base, positioned to receive audible sounds; and
a wireless transmission system mounted within said supporting base, operably connected to said CCD image sensor for transmitting the light received by said CCD image sensor to a remote receiver, and operably connected to said microphone for transmitting the audible sounds received by said microphone;
wherein said wireless transmission system transmits on a frequency of at least 2.4 GHz.

2. A camera system as defined in claim 1, wherein said camera body is rotatably mounted to said supporting base to allow rotation up, down, left and right.

3. A camera system as defined in claim 2, further comprising a supporting arm mounted to said supporting base, wherein said camera body is mounted to said supporting base by said supporting arm.

4. A camera system as defined in claim 3, wherein said camera body can rotate relative to said supporting arm in a first plane, and said supporting arm can rotate relative to said supporting base in a second plane substantially orthogonal to said first plane.

5. A camera system as defined in claim 3, wherein:
said supporting arm is substantially hollow; and
said CCD image sensor and said wireless transmission system are connected by a wire running substantially through said supporting arm from said camera body to said supporting base.

6. A camera system as defined in claim 1, further comprising:
a light source mounted near said lens, to illuminate the area generally in front of said lens, and to increase the light received through said lens.

7. A camera system as defined in claim 6, wherein said light source is an infrared light source.

8. A camera system as defined in claim 6, wherein said light source is a plurality of light emitting diodes.

9. A camera system as defined in claim 8, wherein said plurality of light emitting diodes are arranged in substantially concentric circles around said lens.

10. A camera system as defined in claim 9, wherein said plurality of light emitting diodes are arranged in two substantially concentric circles around said lens.

11. A camera system as defined in claim 1, further comprising:
a wireless reception system mounted within said supporting base, for receiving signals from a remote transmitter; and
a speaker, for projecting audio signals received by said wireless reception system.

12. A camera system as defined in claim 1, wherein said camera system is portable.

13. A camera system as defined in claim 5, wherein said camera system is portable.

14. A camera system for use in a wireless video transmission system, comprising:
a supporting base;
a supporting arm, mounted to said supporting base to allow rotation in a first plane, said supporting arm being substantially hollow;
a camera body mounted to said supporting arm to allow rotation in a second plane substantially orthogonal to said first plane;
a lens mounted to said camera body;
a light source mounted near said lens, to illuminate the area generally in front of said lens, and to increase the light received through said lens;
a CCD image sensor mounted within said camera body, positioned to receive light through said lens;
a microphone, mounted on said supporting base, positioned to receive audible sounds;
a wireless transmission system mounted within said supporting base, operably connected to said CCD image sensor for transmitting the light received by said CCD image sensor to a remote receiver, and operably connected to said microphone for transmitting the audible sounds received by said microphone;
a wire connecting said CCD image sensor and said wireless transmission system, said wire running from said camera body through said hollow supporting arm and into said supporting base;
a wireless reception system mounted within said supporting base, for receiving signals from a remote transmitter; and
a speaker, for projecting audio signals received by said wireless reception system;
wherein said wireless transmission system transmits on a frequency of at least 2.4 GHz.

15. A camera system as defined in claim 14, wherein said light source is a plurality of light emitting diodes arranged in at least two substantially concentric circles around said lens.

16. A camera system as defined in claim 15, wherein said camera system is portable.

17. A monitor system for use in a wireless video transmission system, comprising:
a wireless reception system for receiving signals from a remote transmitter;
an LCD color visual display, for decoding and displaying visual images received by said wireless reception system; and
a speaker, for projecting audio signals received by said wireless reception system;
wherein said wireless reception system receives signals on a frequency of at least 2.4 GigaHertz; and
wherein said monitor system is portable.

18. A monitor system as defined in claim 17, further comprising a first power source comprising direct current batteries.

19. A monitor system as defined in claim 18, further comprising:
a second power source comprising alternating current power;
wherein a user is able to select which of said first power source and said second power source provides power to said monitor system.

20. A monitor system as defined in claim 19, wherein:
said batteries in said first power source are rechargeable batteries; and
said second power source provides sufficient power simultaneously to operate said monitor system and to recharge said batteries.

21. A monitor system as defined in claim 17, further comprising:
a microphone positioned to receive audible sounds; and
a wireless transmission system operably connected to said microphone for transmitting the audible sounds received by said microphone to a remote receiver.

22. A monitor system as defined in claim 20, further comprising:
a microphone positioned to receive audible sounds; and
a wireless transmission system operably connected to said microphone for transmitting the audible sounds received by said microphone to a remote receiver.

23. A monitor system as defined in claim 22, wherein:
said microphone automatically activates upon receiving audio sounds of a predetermined level; and
said wireless transmission system automatically transmits signals corresponding to the audio sounds received by said microphone.

24. A monitor system as defined in claim 22, further comprising:
a microphone control, which is selectively activated by a user and activates said microphone and said wireless transmission system.

25. A monitor system as defined in claim 17, wherein said wireless reception system is capable of simultaneously receiving signals from a plurality of remote transmitters.

26. A monitor system as defined in claim 25, wherein:
said LCD color visual display automatically displays signals received from each of the plurality of remote transmitters for a predetermined period of time, according to a predetermined order; and
said speaker projects audio signals corresponding to the signals simultaneously being displayed by said LCD color visual display.

27. A monitor system as defined in claim 25, further comprising:
one or more input selectors, for selecting which of the signals from the plurality of remote transmitters are to be displayed by said LCD color visual display and to be projected by said speaker.

28. A monitor system as defined in claim 20, wherein said wireless reception system is capable of simultaneously receiving signals from a plurality of remote transmitters.

29. A monitor system as defined in claim 28, wherein:
said LCD color visual display automatically displays signals received from each of the plurality of remote transmitters for a predetermined period of time, according to a predetermined order; and
said speaker projects audio signals corresponding to the signals simultaneously being displayed by said LCD color visual display.

30. A monitor system as defined in claim 28, further comprising:
one or more input selectors, for selecting which of the signals from the plurality of remote transmitters are to be displayed by said LCD color visual display and to be projected by said speaker.

31. A monitor system as defined in claim 22, wherein said wireless reception system is capable of simultaneously receiving signals from a plurality of remote transmitters.

32. A monitor system as defined in claim 31, wherein:
said LCD color visual display automatically displays signals received from each of the plurality of remote transmitters for a predetermined period of time, according to a predetermined order; and
said speaker projects audio signals corresponding to the signals simultaneously being displayed by said LCD color visual display.

33. A monitor system as defined in claim 31, further comprising:
one or more input selectors, for selecting which of the signals from the plurality of remote transmitters are to be displayed by said LCD color visual display and to be projected by said speaker.

34. A monitor system as defined in claim 31, wherein said wireless transmission system transmits signals only to the remote receiver corresponding to the remote transmitter whose signals are being simultaneously being displayed by said LCD color visual display and projected by said speaker.

35. A wireless surveillance system, comprising:
a portable monitor system, comprising:
a first wireless reception system for receiving signals simultaneously from one or more remote transmitters;
an LCD color visual display, for decoding and displaying visual images received by said first wireless reception system; and
a speaker, for projecting audio signals received by said first wireless reception system; and
one or more portable camera systems, each comprising:
a supporting base;
a camera body mounted on said supporting base;
a lens mounted to said camera body;
a CCD image sensor mounted within said camera body, positioned to receive light through said lens;
a microphone, mounted on said supporting base, positioned to receive audible sounds; and
a wireless transmission system mounted within said supporting base, operably connected to said CCD image sensor for transmitting the light received by said CCD image sensor to a remote receiver, and operably connected to said microphone for transmitting the audible sounds received by said microphone;
wherein said wireless transmission system transmits on a frequency of at least 2.4 GHz;
wherein said one or more wireless transmission systems comprise the one or more remote transmitters.

36. A wireless surveillance system as defined in claim 35, wherein said one or more portable camera systems each further comprise:
a second wireless reception system mounted within said camera body, for receiving signals from a remote transmitter; and
a speaker, for projecting audio signals received by said second wireless reception system.

37. A wireless surveillance system as defined in claim 35, wherein said portable monitor system further comprises a first power source comprising direct current batteries.

38. A wireless surveillance system as defined in claim 37, wherein said direct current batteries are rechargeable batteries.

39. A wireless surveillance system as defined in claim 38, wherein:
said portable monitor system further comprises a second power source comprising alternating current power;
wherein a user is able to select which of said first power source and said second power source provides power to said portable monitor system; and
wherein said second power source provides sufficient power simultaneously to operate said portable monitor system and to recharge said batteries.

40. A wireless surveillance system as defined in claim 39, wherein said one or more portable camera systems each further comprise:
a second wireless reception system mounted within said camera body, for receiving signals from a remote transmitter; and
a speaker, for projecting audio signals received by said second wireless reception system.

41. A wireless surveillance system, comprising:
a portable monitor system, comprising:
a first wireless reception system for receiving signals simultaneously from one or more remote transmitters;
an LCD color visual display, for decoding and displaying visual images received by said first wireless reception system; and
a speaker, for projecting audio signals received by said first wireless reception system; and
one or more portable camera systems, each comprising:
a supporting base;
a supporting arm, mounted to said supporting base to allow rotation in a first plane, said supporting arm being substantially hollow;
a camera body mounted to said supporting arm to allow rotation in a second plane substantially orthogonal to said first plane;
a lens mounted to said camera body;
a light source mounted near said lens, to illuminate the area generally in front of said lens, and to increase the light received through said lens;
a CCD image sensor mounted within said camera body, positioned to receive light through said lens;
a microphone, mounted on said supporting base, positioned to receive audible sounds;
a wireless transmission system mounted within said supporting base, operably connected to said CCD image sensor for transmitting the light received by said CCD image sensor to a remote receiver, and operably connected to said microphone for transmitting the audible sounds received by said microphone;
a wire connecting said CCD image sensor and said wireless transmission system, said wire running from said camera body through said hollow supporting arm and into said supporting base;
a wireless reception system mounted within said supporting base, for receiving signals from a remote transmitter; and
a speaker, for projecting audio signals received by said wireless reception system;
wherein said wireless transmission system transmits on a frequency of at least 2.4 GHz;
wherein said one or more wireless transmission systems comprise the one or more remote transmitters.

42. A wireless reception system, comprising:
a receiver adapted to wirelessly receive video and audio signals from a plurality of remote sources at a frequency of at least 2.4 GigaHertz;
a plurality of source selector controls, each said source selector control determining which of the plurality of remote sources is selected;
a plurality of source indicators, each said source indicator corresponding to a remote source, and indicating whether the remote source is selected;
a scan selector control, directing said wireless reception system to alternately select each remote source for a predetermined period of time; and
an output jack, for outputting signals from the selected remote source to a display and speaker.

43. A wireless reception system as defined in claim 42, wherein said predetermined period of time can be selected or modified by a user.

44. A wireless reception system as defined in claim 43, wherein said predetermined period of time can be different for each remote source.

45. A wireless reception system as defined in claim 43, further comprising:
a remote control allowing a user to select said scan selector control, select each of said plurality of source selector controls, and select or modify said predetermined period of time remotely.

46. A wireless reception system as defined in claim 42, wherein said output jack is a coaxial cable jack.

47. A wireless reception system as defined in claim 46, further comprising an audio/video output.
